(19) United States
(12) Patent Application Publication
(10) Pub. No.: US 2015/0106652 A1
(43) Pub. Date: Apr. 16, 2015

(54) SYSTEM REPAIR METHOD AND DEVICE, AND STORAGE MEDIUM

(71) Applicant: Tencent Technology (Shenzhen) Company Limited, Shenzhen (CN)

(72) Inventors: Shuhui MEI, Shenzhen (CN); Hong SHANG, Shenzhen (CN)

(21) Appl. No.: 14/575,680

(22) Filed: Dec. 18, 2014

Related U.S. Application Data
(63) Continuation of application No. PCT/CN2013/077782, filed on Jun. 24, 2013.

(30) Foreign Application Priority Data
Jun. 25, 2012 (CN) 201210210425.6

(51) Int. Cl. G06F 11/14; G06F 11/07

(52) U.S. Cl. CPC G06F 11/1458; G06F 11/1448; G06F 11/0793; G06F 2201/82; G06F 2201/84
USPC 714/19

(57) ABSTRACT

A system repair method and device, and a storage medium are provided. The system repair method includes: performing security check on system files and registries in a system; when the detection result is abnormal, judging whether the system files and/or the g registries are required to be repaired according to preset system repair rules; and if yes, repairing the system files and/or the registries. The present invention avoids possible abnormal repair in system repair, reduces risks in the system repair, improves security and accuracy of the system repair, and ensures reliability of the system repair.

### CROSS-REFERENCE TO RELATED APPLICATIONS

This application is a continuation application of International Application PCT/CN2013/077782, entitled “SYSTEM REPAIR METHOD AND DEVICE, AND STORAGE MEDIUM”, filed on Jun. 24, 2013, which claims priority to Chinese patent application No. 201210210425.6, titled “SYSTEM REPAIR METHOD AND DEVICE, AND STORAGE MEDIUM” and filed with the State Intellectual Property Office on Jun. 25, 2012, which are both incorporated herein by reference in entirety.

### FIELD

The present disclosure relates to technologies for operating system repair, and in particular, to a method and device for system repair, and a storage medium.

### BACKGROUND

System files and the registry are important for the Windows operating system. The system files are major files of the operating system, which are created automatically and stored in a corresponding folder during the installation of the operating system. The system files affect the normal running of the system and most of the system files are not allowed to be modified arbitrarily. Therefore, the system files are important for maintaining the stability of the system in a computer. The registry is an important database in the Windows operating system, which is used to store setting of the system and application programs. The registry is composed of keys (or referred to as “entries”), sub-keys (sub-entries) and values. A key is a folder in a branch; the sub-key is a sub-folder in the folder and the sub-key is also a key; and a registry value is a current definition of a key and includes a name, a data type and an assigned value. One key may have one or more values with different names, and the value with the null name is the default value of the key.

There are defects in the existing methods for system repair and an improved method is desirable.

### SUMMARY

The present disclosure is to provide a method and device for system repair, and a storage medium, to avoid a possible abnormality in the system repair and ensure reliability of the system repair.

For this purpose, the present disclosure provides a method for system repair, including:

performing a security check on a system file and a registry in the system;

determining whether it is needed to repair the system file and/or the registry according to a preset rule for the system repair, in the case that a result of the security check indicates an abnormality; and

repairing the system file and/or the registry in the case that it is needed to repair the system file and/or the registry.

The present disclosure further provides a device for system repair, including:

a security-checking module, configured to perform a security check on a system file and a registry in the system;

a repair-determining module, configured to determine whether it is needed to repair the system file and/or the registry according to a preset rule for the system repair, in the case that a result of the security check indicates an abnormality; and

a repair module, configured to repair the system file and/or the registry in the case that the repair-determining module determines that it is needed to repair the system file and/or the registry

The present disclosure further provides a computer readable storage medium, on which a program enabling a computer to run is stored, where after being loaded into a storage of the computer, the program enables the computer to: perform a security check on a system file and a registry in a system, determine whether it is needed to repair the system file and/or the registry according to a preset rule for the system repair in the case that a result of the security check indicates an abnormality, and repair the system file and/or the registry in the case that it is needed to repair the system file and/or the registry.

With the method and device for repairing the system and the storage medium which are provided by the present disclosure, the possible abnormality in the system repair is avoided, risks in the system repair are reduced, security and accuracy of the system repair are improved, and reliability of the system repair is ensured.

### BRIEF DESCRIPTION OF THE DRAWINGS

FIG. 1 is a flowchart of a method for system repair according to a first embodiment of the present disclosure;

FIG. 2 is a flowchart of a method for system repair according to a second embodiment of the present disclosure;

FIG. 3 is a schematic diagram showing settings of user registry entries in the method for system repair according to the second embodiment of the present disclosure;

FIG. 4 is a flowchart of a method for system repair according to a third embodiment of the present disclosure;

FIG. 5 is a schematic structural diagram of a device for system repair according to an embodiment of the present disclosure;

FIG. 6 is a schematic structural diagram of a device for system repair according to another embodiment of the present disclosure; and

FIG. 7 is a schematic structural diagram of a device for system repair according to yet another embodiment of the present disclosure.

For better understanding, the technical solution according to the present disclosure will be described in detail in conjunction with the drawings.

### DETAILED DESCRIPTION

In an embodiment of the present disclosure, a security check is performed on a system file and a registry, whether a system needs to be repaired is determined based on a result of the security check, and repair is performed on the system file and/or the registry if the system needs to be repaired. In addition, after the system is repaired, whether the system repair is abnormal is further detected. If the system repair is abnormal, the system is recovered to a normal status according to status information of the system which is previously recorded; further, a designated restore may be performed manually to improve reliability of the system repair.

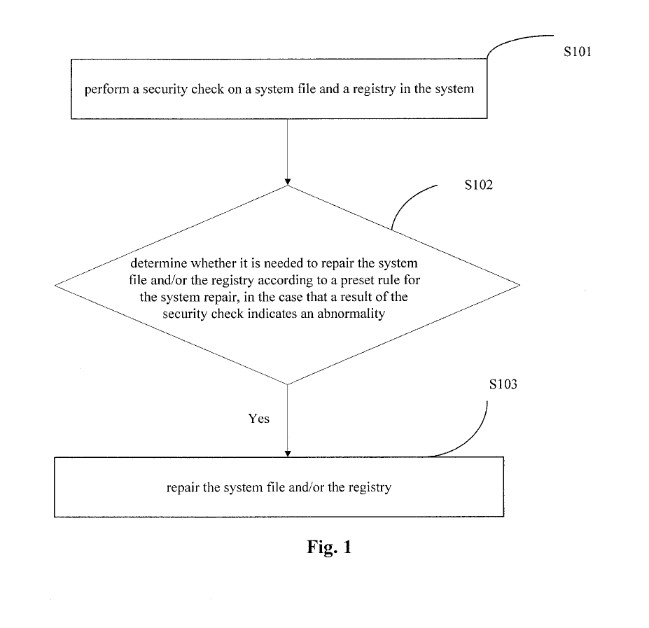

As shown in FIG. 1, a method for system repair according to a first embodiment of the present disclosure includes steps S101 to S103.

In step S101, a security check is performed on a system file and a registry.

According to an embodiment of the disclosure, for the system repair in case of a failure in the system, not only the system file but also the registry of the system is checked and repaired to improve reliability of the system repair and avoid an abnormality in the system repair.

Firstly, the security check is performed on the system file and the registry in the system to determine whether there is a potential security issue.

In an exemplary embodiment, the security check for the system file includes checking whether the current system file matches with the current operating system. For example, the system file may be scanned, and whether the system file is a risk file is determined by querying with the MD5 of the system file in the background. If an abnormality is reported from the background, it is indicated that the system file needs to be repaired; and if it is reported from the background the system file is not risky, the system file is graded in terms of importance and the signature of the system file is authenticated in the case that the system file is graded as important. If the signature of the system file does not pass the authentication, it is indicated that the system file does not match with the current system, there is a risk and the system file needs to be repaired; and if the signature of the system file passes the authentication, it is indicated that the security status of the system file is normal.

In another exemplary embodiment, the security check for the registry includes checking whether there is a maliciously modified entry in current information of the registry. For example, the current values in the registry are compared to default values in the registry to determine whether there is a modification in the current value(s) of the registry. If there is a modification and the modification is abnormal (for example, modifying the value from 0 to 1), it is determined that the registry needs to be repaired; if the modification of the registry is directed to a file, the file is checked for example by querying with the MD5 of the file in the background to determine whether the file is a risk file. If the file is risky, it is indicated that the registry needs to be repaired; and if the file is not risky, it is indicated that the registry does not need to be repaired.

The security status of the system may be determined by checking the system file and the registry. For example, a Trojan program named Trojan.Neprodoor may infect a file named ndis.sys in the system; moreover, this Trojan program may modify a startup entry in the registry of the system, hence the Trojan program process is loaded when the system is started. This Trojan program not only enables the drive file ndis.sys to maintain the original function, but also injects a backdoor program into a Service.exe program. This Trojan program may run to stolen user information in response to received remote instructions. Consequently, by the security check on the system, it is checked that the system file ndis.sys is modified by a virus and thus the system file is abnormal. In addition, by the security check, it is checked that the startup entry of the registry is also modified as pointing to the virus process, and thus the startup entry pointing to the virus process is also abnormal.

In step S102, whether it is needed to repair the system file and/or the registry is determined according to a preset rule for the system repair in the case that the result of the security check indicates an abnormality; once it is needed to repair the system file and/or the registry, the method proceeds to step S103.

In the case that the result of the security check for the system in step S101 indicates that there is an abnormality, whether the system needs to be repaired is determined according to the preset rule for the system repair.

According to an exemplary embodiment, the rule for the system repair may be set as follows: the system files are graded into important files and unimportant files. The important files include files that matter the start and running of the operating system to the extent that once the files are infected or destroyed, the system may fail in startup or normal operation, or the virus process may be loaded; therefore, the important system files need to be repaired once there are destroyed, such as the file kernel32.dll in the folder of Windows\system32. The unimportant files include the system files having a smaller effect or no effect on the system security, or those files that are rarely infected by the virus process; it is unnecessary to repair the unimportant files so long as the unimportant files do not affect the system security.

According to an exemplary embodiment, for determining whether the registry needs to be repaired, the rule for the system repair may be set as follows: current information of the registry is compared to default settings of corresponding entries in the registry to determine whether the registry needs to be repaired.

The registry entries are graded into important entries and unimportant entries. The important entries include entries prone to be modified by a Trojan program or a virus to load a process, and entries prone to be modified by user or applications; and the unimportant entries include the entries that are rarely modified.

Whether the system needs to be repaired is determined by comparing with system default entries detecting user modified entries and checking the security of files pointed by the user modified entries. If it is determined that certain registry entries are modified maliciously or files that certain startup entries point to are dangerous files, the registry entries need to be repaired.

In step S103, repair is performed on the system file and/or the registry.

If it is determined that the system needs to be repaired after the repair determination, the system file or the registry entry is repaired based on the determination result.

The repair for system file may includes: if it is found that a system file is modified, checking version information of the system file firstly, then checking the security of the modified file in the background; and if it is found that the system file is deleted or modified, importing the system file from a preset standard library or replacing the system file.

The repair for the registry may include: restoring values of modified entries in the registry to system default secure settings or to user modified settings in the registry.

For example, if it is detected that a drive file serial.sys in the system is infected by a virus, a copy of the file is found from the standard library to replace the infected file. To repair a registry, whether the registry needs to be deleted is determined firstly; if the registry entry is a startup entry pointing to a dangerous file, the startup entry needs to be deleted from the registry; and other secure startup entries modified by a user or applications may be retained. For another example, for the registry entry representing the homepage of IE, once it is detected that the value of the entry points to a website including a Trojan program, the value may be modified to the default value of blank.

In the embodiment, the security check is performed on the system file and the registry, whether the system needs to be repaired is determined based on the result of the security check, and repair is performed on the system file and/or the registry if the system needs to be repaired. Accordingly, risk in the system repair is reduced, and security and accuracy of the system repair are improved.

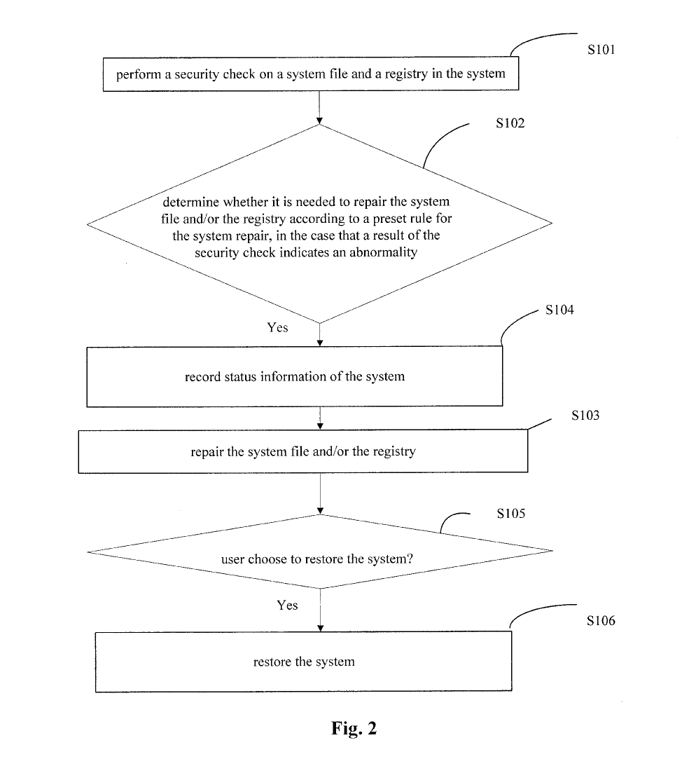

As shown in FIG. 2, a method for system repair is provided according to a second embodiment of the present disclosure, which further includes steps S104, S105 and S106 in addition to the steps in the first embodiment.

The method further includes step S104 in which status information of a system is recorded after it is determined in the step S102 that it is needed to repair the system file and/or the registry.

After repair is performed on the system file and/or the registry in the step S103, the method further includes steps as follows.

In step S105, whether a user chooses to restore the system is determined, and the method proceeds to step S106 if the user chooses to restore the system; in step S106, the system is restored.

This embodiment differs from the first embodiment in that the system is restored in the case that the user chooses to restore the system after the system is repaired.

Specifically, in order to restore the system, the status information of the system is recorded in the case that it is determined that the system file and/or the registry need(s) to be repaired.

According to an exemplary embodiment, recording the status information of the system includes recording status information of the system files and recording status information of the registry, and creating status information tables of the system files and the registry respectively. The recorded status information of the system is used to restore the system in the case that the system repair is failed or the user chooses to restore the system. The following approach for recording the status information of the system is employed in the embodiment.

The status information of the system file may include: the number of the system files, the names of the system files, version information of the system files and verification information of the system files. The status information of the system files is backed up while being recorded. The status information of the system files may be recorded in the format as shown in the following Table 1:

TABLE 1

| | Number of | | Verification |
|---|---|---|---|
| File type | Files/File name | File version | information |
| Kernel File | 8 | — | — |
| | kernel 31.dll | Version 1 | MD5₁ |
| | at171.dll | Version 2 | MD5₂ |
| | Other files of the | — | MD5₃ |
| | kernel | | |
| Drive file | 10 | — | — |
| | fastfat.sys | Version 3 | MD5₄ |
| | flpydisk.sys | Version 4 | MD5₅ |
| | serial.sys | Version 5 | MD5₆ |
| | Other files of the | — | MD5₇ |
| | drive | | |

Given the tremendous number of system files, efficiency in recording and subsequent querying may be adversely affected if all of the files are recorded. Thus, a shifted compression may be employed in a preferable embodiment of the present disclosure, in which the recording for the system files which are non-common and are not prone to be modified is performed in unit of folders, that is, only recording the number and the verification information of files in the folder rather than recording version information of each file, so as to reduce a storage amount of the recorded information and improve recording efficiency.

Moreover, MD5 information of files of various types needs to be recorded, on which a MD5 encryption is performed, for a subsequent determination for system restoring. For example, MD513 (MD51, MD52 and MD53) is obtained by encrypting the verification information of the kernel, MD547 (MD54, MD55 and MD 56) is obtained by encrypting the verification information of the drive, and MD517 which records the status information of the system files as a whole is obtained finally.

Recording the status information of the registry in the system may includes recording a key value of each entry in a system default status table and recording a key value of each entry in the registry modified by the user or applications. The format of the recording may be as shown in the following Table 2:

TABLE 2

| Registry | Registry | | Default | Current | To be modified |
|---|---|---|---|---|---|
| type | entry | Level | value | value | or not |
| HKEY_DLASSES_ROOT | Entry 1 | Important | 1 | 1 | No |
| | Entry 2 | Important | 1 | 0 | Yes |
| | Other entries | Unimportant | 0 | 0 | No |
| HKEY_USERS | Entry 1 | important | 0 | 0 | No |
| | Entry 2 | Important | 1 | 0 | Yes |
| | Entry 3 | Important | 0 | 1 | Yes |
| | Other entries | Unimportant | 1 | 1 | No |

Since there are many registry entries in the system, including 5 main types with each type containing many entries each of which contains many sub-entries, if status information of each sub-entry is recorded, a large storage space is needed and efficiency of subsequent query is low. Therefore, in the exemplary embodiment, the status information of the registry may be compressed when being recorded to improve the storage efficiency and speed of subsequent query.

In an exemplary implementation, a registry is divided into 5 parts which correspond to the 5 main types of entries in the registry. For each type, registry entries are classified into important registry entries and unimportant registry entries. Specifically, the important entries include entries that are related to the system security and are often taken advantage by Trojan program or virus software, such as a system startup entry, an IE default entry, a system-service-related entry and a protocol-related entry, and further include entries which may be modified by the user, such as an entry indicating the open mode that may be modified due to a software installation. The unimportant registry entry refers to such a entry that may be rarely modified.

For the unimportant entries, all of default values are mapped to one value, while for the important entries, each entry corresponds to one value; then a union of all the values of the important entries and the mapped value of the unimportant entries is calculated to determine whether the registry is modified.

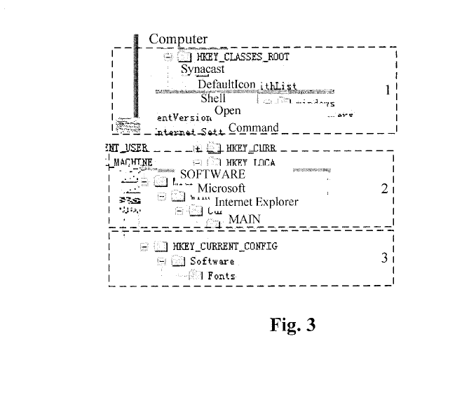

FIG. 3 is a schematic diagram showing settings of user registry entries. Specifically, registry entry 1 is modified due to the installation of PPlive; registry entry 2 is a registry entry indicating an IE default homepage; registry entries 1 and 2 are both important registry entries. Registry entry 3, which is not prone to be used and modified frequently, is an unimportant registry entry.

Similar to the recording of the status information of the system files, the status information of the registry is recorded in a manner that important entries and unimportant entries are recorded respectively, records for the important and unimportant entries are merged into a record for this type of entries, and then the records of all types of entries are merged into information of the whole registry.

For example, in FIG. 3, information of important registry entry 1 is: HKEY_CLASSES_ROOT\Synacast\Shell\Open\Command“C:\Program Files\PPLiye\PPTV\PPLiye.exe” “%1”, which is encrypted into MD51; information of important registry entry 2 is: HKEY_LOCAL_MACHINE\SOFTWARE\Microsoft\Internet Explorer\MAIN\Start Page http://www.google.com.hk, which is encrypted into MD52. MD512 (MD51 and MD52) is obtained by re-encrypting the information of the important registry entries 1 and 2. Information of unimportant registry entry 3 is: HKEY_CURRENT_CONFIG\Software\Fonts, which is encrypted into MD53. Finally, MD 513 (MD512 and MD53) is obtained to represent the recorded information of the whole registry.

MD5 encryption is used here, but other encryption may be also used in practice to acquire information of the whole system.

If a user wants to restore the system after the system is repaired, the system files and the registry are respectively restored to a pre-repair status, according to the previously recorded status information of the system before the system repair. An exemplary restoring is as follows.

For a system file, a status information table of the system file is searched; a type of the modification performed on the system file is determined based on MD5 information; then a corresponding important or unimportant file set is searched in the same way; finally, corresponding version information and verification information are found, and a corresponding system file is searched among backup files, with which the system file is restored.

For the registry, there are two ways for restoring: one way is to search an original setting of a modified registry entry according to recorded status information of the registry and restore the repaired setting to the original setting; the other way is to feedback the modification of the registry to the user to enable the user to designate an entry to be restored manually.

An approach for restoring the registry is similar to the approach for restoring the system file, and the approach includes: finding a corresponding registry entry of a corresponding type and restoring the registry entry into a recorded status until the restoring is finished.

In the embodiment, a security check is performed on a system file and a registry, whether a system needs to be repaired is determined based on a result of the security check, and repair is performed on the system file and/or the registry if the system needs to be repaired. In addition, after a system is repaired, the user who wishes to restore the system may perform a manual restoring to a designated content based on the previously recorded status information of the system. Therefore, risk in the system repair is reduced, security and accuracy of the system repair are improved and the restore of the system is facilitated.

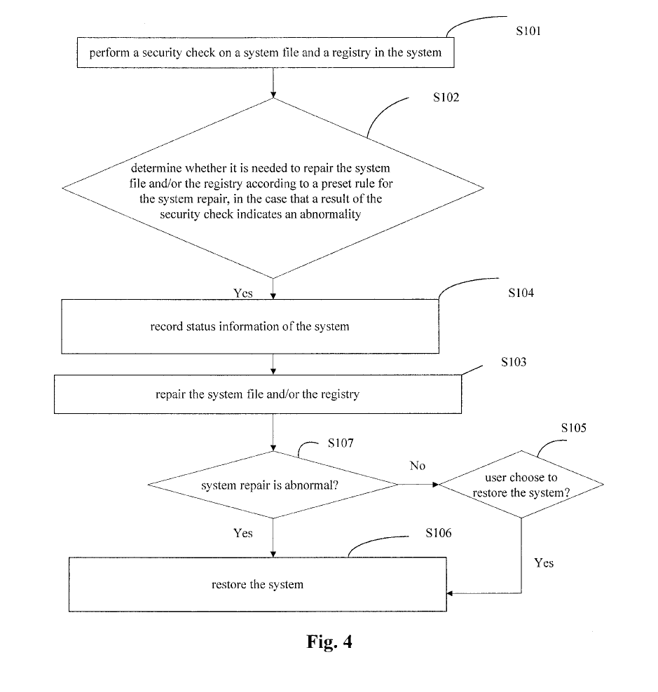

As shown in FIG. 4, a method for system repair is provided according to a third embodiment of the present disclosure, on the basis of the second embodiment. After repair is performed on the system file and/or the registry in the step S103, the method further includes step S107.

In step S107, whether the system repair is abnormal is determined. If the system repair is abnormal, step S106 is performed; otherwise, step S105 is performed.

This embodiment differs from the second embodiment in that, after the system is repaired, whether the system repair is abnormal is determined, and the system is restored if the system repair is abnormal.

Specifically, in the embodiment, status information of the system is recorded in the case that the system file and/or the registry need(s) to be repaired, to be used in the restore of the system. The process is the same as that in the second embodiment and will not be described here.

There may be certain risks in repairing the system file and the system registry. A failure in the repair may result in a new problem or even result in a crash of the system. Therefore, it is determined at the end of the system repair whether there is abnormality in the repair.

For example, for such a case that a restoring strategy for the registry is to restore the registry with default values while the Trojan program or virus checks whether a registry entry is repaired at regular intervals and overwrites the registry entry once the registry entry is repaired, it is not reasonable to restore the registry with the default values directly because the registry may be overwritten after being repaired. In the case that certain entries, which were repaired by security software in the system, are overwritten, it is determined that the system repair is abnormal.

Specifically, a strategy for determining whether the repair for a system file is abnormal may include performing an abnormality monitoring for the repaired system file and the repaired registry. For example, the monitoring may include: submitting the system file on which the repair was performed and the system file used in the repair to a background server to confirm that the system file on which the repair was performed may bring in a system security issue and the system file used in the repair may not bring in the security issue. By performing the abnormality monitoring on the system file used in the repair, a re-infection of the repaired system file may be detected and the repair is determined as an abnormal repair, hence a repeat overwrite by the virus is avoided.

For the repair of the registry, if a strategy for repairing the registry is to restore the registry with default registry values, it may be checked whether the restored default registry values are overwritten by the virus; and in the case that certain entries repaired by the system security software are overwritten, it is determined that the repair is abnormal.

Moreover, if the strategy for repairing the registry is to modify the registry by user or by the system security software, the registry modified according to the modification strategy is compared to the modification for the registry made by the user or system security software before the system repair. Furthermore, an attribute of a file corresponding to the modified entry is checked and a security verification is performed. If there is no user setting value for the registry entry to be modified, the registry entry is modified to a default value and the repair is determined as normal. If there is a user setting value for the registry entry to be modified, the object directed by the user setting value is determined and the object is submitted to the background to detect whether there is a security risk. If there is the security risk, it is determined that the repair is abnormal; and if there is no security risk, it is determined that the repair is normal.

It should be noted that, for the repair strategy of the registry, the repaired registry entries are compared with the registry entries before the repair to determine whether there is a user-modified entry, the value of user-modified entry is searched and the security of the user-modified entry is checked, to determine whether the entry is set with the default value in accordance with the repair strategy or is modified to the user setting value before being modified by the virus. If no security risk will be brought by the user setting value while the registry entry is set as the default value according to the modification strategy, it is considered that the repair is abnormal; or if the user does not modify the entry but the registry entry is modified to a non-default value according to the strategy, it is also determined that the repair is abnormal.

In the case that it is determined that the system repair is abnormal or the user needs to restore the repaired system manually, it is necessary to restore the repaired system to avoid other system issues caused by the abnormal repair. The system file and the registry are each restored to the status before the system repair according to the status information of the system which is recorded before the system repair. A restoring approach is as follows.

For a system file, a status information table of the system file is searched; a type of the modification performed on the system file is determined based on MD5 information; then a corresponding important or unimportant file set is searched in the same way; finally, corresponding version information and verification information are found, and a corresponding system file is searched among backup files, with which the system file is restored.

As shown in Table 1, if it is determined that the system repair is abnormal, a change in MD517 is firstly determined; then a change in drive verification information MD547 is found out; finally, it is determined that the abnormality is caused by the change in MD54 as a result for repairing a system file: fastfat.sys; accordingly, this system file is restored.

For the registry, there are two ways for restoring: one way is to search an original setting of a modified registry entry according to recorded status information of the registry and restore the repaired setting to the original setting; the other way is to feedback the modification of the registry to the user to enable the user to designate an entry to be restored manually.

An approach for restoring the registry is similar to the approach for restoring the system file, and the approach includes: finding a corresponding registry entry of a corresponding type and restoring the registry entry into a recorded status until the restoring is finished.

In the embodiment, a security check is performed on a system file and a registry, whether a system needs to be repaired is determined based on a result of the security check and repair is performed on the system file and/or the registry if the system needs to be repaired. In addition, after the system is repaired, whether the system repair is abnormal is further detected, and if the system repair is abnormal, the system is recovered to a normal status according to status information of the system which is previously recorded; and a designated restore may be also performed manually. If the system repair is normal, it is determined that the system repair is completed. Therefore, possible abnormality in the system repair is avoided, risk in the system repair is reduced, and security, accuracy and reliability of the system repair are improved.

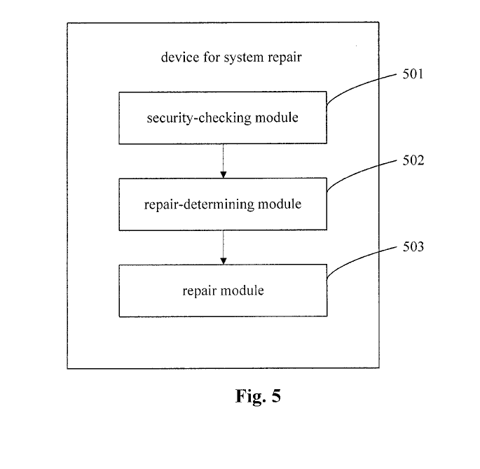

As shown in FIG. 5, a device for system repair is provided by an embodiment according to the present disclosure, including: a security-checking module 501, a repair determining module 502 and a repair module 503.

The security-checking module 501 is configured to perform a security check on a system file and a registry in the system.

The repair-determining module 502 is configured to determine according to a preset rule for the system repair whether it is needed to repair the system file and/or the registry, in the case that a result of the security check indicates an abnormality.

The repair module 503 is configured to repair the system file and/or the registry if the repair-determining module determines that it is needed to repair the system file and/or the registry.

According to an embodiment of the disclosure, for the system repair in case of a failure in the system, not only the system file but also the registry of the system is checked and repaired to improve reliability of the system repair and avoid an abnormality in the system repair.

Firstly, the security check module 501 performs the security check on the system file and the registry in the system to determine whether there is a potential security issue.

The security check for the system file, for example, may include checking whether the current system file matches with the current operating system. The system file may be scanned, and whether the system file is a risk file is determined by querying with the MD5 of the system file in the background. If an abnormality is reported from the background, it is indicated that the system file needs to be repaired; and if it is reported from the background the system file is not risky, the system file is graded in terms of importance and the signature of the system file is authenticated in the case that the system file is graded as important. If the signature of the system file does not pass the authentication, it is indicated that the system file does not match with the current system, there is a risk and the system file needs to be repaired; and if the signature of the system file passes the authentication, it is indicated that the security status of the system file is normal.

For the security check for the registry may include, for example, checking whether there is a maliciously modified entry in current information of the registry. The current values in the registry are compared to default values in the registry to determine whether there is a modification in the current value(s) of the registry. If there is a modification and the modification is abnormal (for example, modifying the value from 0 to 1), it is determined that the registry needs to be repaired; if the modification of the registry is directed to a file, the file is checked for example by querying with the MD5 of the file in the background to determine whether the file is a risk file. If the file is risky, it is indicated that the registry needs to be repaired; and if the file is not risky, it is indicated that the registry does not need to be repaired.

The security status of the system may be determined by checking the system file and the registry. For example, Trojan program named Trojan.Neprodoor may infect a file named ndis.sys in the system; moreover, this Trojan program may modify a startup entry in the registry of the system, hence the Trojan program process is loaded when the system is started. This Trojan program not only enables the drive file ndis.sys to maintain the original function, but also injects a backdoor program into a Service.exe program. This Trojan program may run to stolen user information in response to received remote instructions. Consequently, by the security check on the system, it is checked that the system file ndis.sys is modified by a virus and thus the system file is abnormal. In addition, by the security check, it is checked that the startup entry of the registry is also modified as pointing to the virus process, and thus the startup entry pointing to the virus process is also abnormal.

The repair-determining module 502 determines whether the system needs to be repaired according to the result of the security check in the system obtained by the above security check module 501 and a preset rule for the system repair.

For determining whether the system file needs to be repaired, the rule for the system repair may be set as follows: the system files are graded into important files and unimportant files. The important files include files that matter the start and running of the operating system to the extent that once the files are infected or destroyed, the system may fail in startup or normal operation, or the virus process may be loaded; therefore, the important system files need to be repaired once there are destroyed, such as the file kernel32.dll in the folder of Windows\system32. The unimportant files include the system files having a smaller effect or no effect on the system security, or those files that are rarely infected by the virus process; it is unnecessary to repair the unimportant files so long as the unimportant files do not affect the system security.

For determining whether the registry needs to be repaired, the rule for the system repair may be set as follows: current information of the registry is compared to default settings of corresponding entries in the registry to determine whether the registry needs to be repaired.

The registry entries are graded into important entries and unimportant entries. The important entries include entries prone to be modified by a Trojan program or a virus to load a process, and entries prone to be modified by user or applications; and the unimportant entries include the entries that are rarely modified.

Whether the system needs to be repaired is determined by comparing with system default entries detecting user modified entries and checking the security of files pointed by the user modified entries. If it is determined that certain registry entries are modified maliciously or files that certain startup entries point to are dangerous files, the registry entries need to be repaired.

If it is determined that the system needs to be repaired after the repair-determination, the repair module 503 repairs the system file or the registry entry based on the determination result. In an exemplary embodiment, the repair module 503 is configured as follows.

For the repair for system file, if it is found that a system file is modified, the repair module 503 checks version information of the system file firstly, then calls the background to check the security of the modified file; and if it is found that the system file is deleted or modified, the repair module 503 imports the system file from a preset standard library or replaces the system file.

For the repair for registry, the repair module 503 restores values of modified entries in the registry to system default secure settings or to user modified settings in the registry.

For example, if it is detected that a drive file serial.sys of the system is infected by a virus, the repair module 503 is configure to find out a copy of the file from the standard library to replace the infected file. To repair a registry, whether the registry needs to be deleted is determined firstly; if the registry entry is a startup entry pointing to a dangerous file, the repair module 503 is configured to delete the startup entry from the registry; and other secure startup entries modified by a user or applications may be retained by the repair module 503; for another example, for the registry entry representing the homepage of IE, once it is detected that the value of the entry points to a website including a Trojan program, the repair module 503 is configured to modify the value to the default value of blank.

In the embodiment, the security check is performed on the system file and the registry, whether the system needs to be repaired is determined based on the result of the security check, and repair is performed on the system file and/or the registry if the system needs to be repaired. Accordingly, risk in the system repair is reduced, and security and accuracy of the system repair are improved

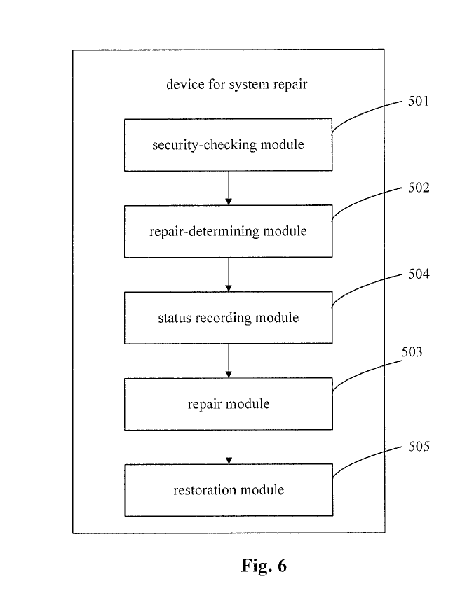

As shown in FIG. 6, a device for system repair is provided according to another embodiment of the present disclosure. The device further includes a status-recording module 504 and a restoration module 505 in addition to those elements in the former embodiment.

The status-recording module 504, connected to the repair-determining module 502 and the repair module 503, is configured to record status information of the system.

The restoration module 505, connected to the repair module 503, is configured to restore the system.

This embodiment differs from the former embodiment in that the system is restored in the case that the user chooses to restore the system after the system is repaired.

Specifically, in order to restore the system, the status-recording module 504 records the status information of the system in the case that it is determined that the system file and/or the registry need(s) to be repaired.

Recording the status information of the system includes recording status information of the system files and recording status information of the registry, and creating status information tables of the system files and the registry respectively. The recorded status information of the system is used to restore the system in the case that the system repair is failed. And the following approach for recording the status information of the system is employed in the embodiment.

The status information of the system file may include: the number of the system files, the names of the system files, version information of the system files and verification information of the system files. The status information of the system files is backed up while being recorded. The status information of the system files may be recorded in the format as shown in the above Table 1.

Given the tremendous number of system files, efficiency in recording and subsequent querying may be adversely affected if all of the files are recorded. Thus, a shifted compression may be employed in a preferable embodiment of the present disclosure, in which the recording for the system files which are non-common and are not prone to be modified is performed in unit of folders, that is, only recording the number and the verification information of files in the folder rather than recording version information of each file, so as to reduce a storage amount of the recorded information and improve recording efficiency.

Moreover, MD5 information of files of various types needs to be recorded, on which a MD5 encryption is performed, for a subsequent determination for system restoring. For example, MD513 (MD51, MD52 and MD53) is obtained by encrypting the verification information of the kernel, MD547 (MD54, MD55 and MD 56) is obtained by encrypting the verification information of the drive, and MD517 which records the status information of the system files as a whole is obtained finally.

Recording the status information of the registry in the system denotes recording a key value of each entry in a system default status table and recording a key value of each entry in the registry modified by the user or applications. The r format of the recording may be as shown in the above Table 2

Since there are many registry entries in the system, including 5 main types with each type containing many entries each of which contains many sub-entries, if status information of each sub-entry is recorded, a large storage space is needed and efficiency of subsequent query is low. Therefore, in the exemplary embodiment, the status information of the registry may be compressed when being recorded to improve the storage efficiency and speed of subsequent query.

In an exemplary implementation, a registry is divided into 5 parts which correspond to the 5 main types of entries in the registry. For each type, registry entries are classified into important registry entries and unimportant registry entries. Specifically, the important entries include entries that are related to the system security and are often taken advantage by Trojan program or virus software, such as a system startup entry, an IE default entry, a system-service-related entry and a protocol-related entry, and further include entries which may be modified by the user, such as an entry indicating the open mode that may be modified due to a software installation. The unimportant registry entry refers to such a entry that may be rarely modified.

For the unimportant entries, all of default values are mapped to one value, while for the important entries, each entry corresponds to one value; then a union of all the values of the important entries and the mapped value of the unimportant entries is calculated to determine whether the registry is modified.

Reference is made to FIG. 3, which is a schematic diagram showing settings of user registry entries. Specifically, registry entry 1 is modified due to the installation of PPlive; registry entry 2 is a registry entry indicating an IE default homepage; registry entries 1 and 2 are both important registry entries. Registry entry 3, which is not prone to be used and modified frequently, is an unimportant registry entry.

Similar to the recording of the status information of the system files, the status information of the registry is recorded in a manner that important entries and unimportant entries are recorded respectively, records for the important and unimportant entries are merged into a record for this type of entries, and then the records of all types of entries are merged into information of the whole registry.

Similar to the recording of the status information of the system files, the status information of the registry is recorded in a manner that important entries and unimportant entries are recorded respectively, records for the important and unimportant entries are merged into a record for this type of entries, and then the records of all types of entries are merged into information of the whole registry.

MD5 encryption is used here, but other encryption may be also used in practice to acquire information of the whole system.

If a user wants to restore the system after the system is repaired, the restoration module 505 restores the system files and the registry respectively to a pre-repair status, according to the previously recorded status information of the system before the system repair. In an exemplary embodiment, the restoration module 505 is configured to function in the following way.

For a system file, a status information table of the system file is searched; a type of the modification performed on the system file is determined based on MD5 information; then a corresponding important or unimportant file set is searched in the same way; finally, corresponding version information and verification information are found, and a corresponding system file is searched among backup files, with which the system file is restored.

For the registry, there are two ways for restoring: one way is to search an original setting of a modified registry entry according to recorded status information of the registry and restore the repaired setting to the original setting; the other way is to feedback the modification of the registry to the user to enable the user to designate an entry to be restored manually.

An approach for restoring the registry is similar to the approach for restoring the system file, and the approach includes: finding a corresponding registry entry of a corresponding type and restoring the registry entry into a recorded status until the restoring is finished.

In the embodiment, a security check is performed on a system file and a registry, whether a system needs to be repaired is determined based on a result of the security check, and repair is performed on the system file and/or the registry if the system needs to be repaired. In addition, after a system is repaired, the user who wishes to restore the system may perform a manual restoring to a designated content based on the previously recorded status information of the system. Therefore, risk in the system repair is reduced, security and accuracy of the system repair are improved and the restore of the system is facilitated.

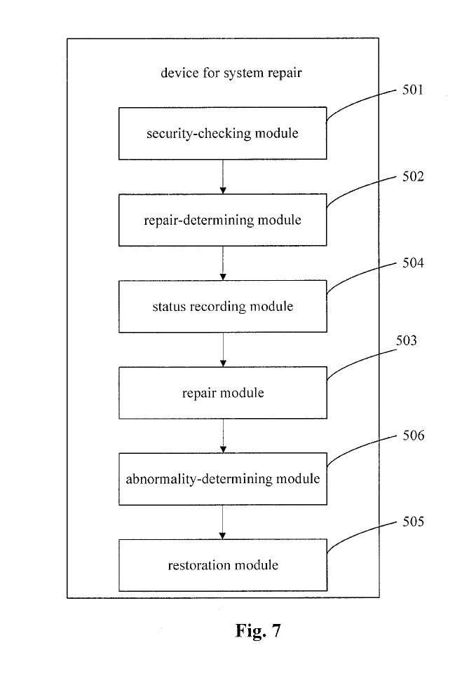

As shown in FIG. 7, a device for system repair is provided according yet another embodiment of the present disclosure. Based on the former embodiment, the device further includes an abnormality-determining module 506.

The abnormality-determining module 506 and the restoration module 505 are both connected to the repair module 503; the abnormality-determining module 506 is configured to determine whether the system repair is abnormal, and the restoration module 505 restores the system if the system repair is abnormal.

This embodiment differs from the former embodiment in that, after the system is repaired, whether the system repair is abnormal is determined, and the system is restored if the system repair is abnormal.

In the embodiment, for the purpose of system restore, the status-recording module 504 records status information of the system in the case that the system file and/or the registry need(s) to be repaired. The process is the same as that in the former embodiment and will not be described hereinafter.

There may be certain risks in repairing the system file and the system registry. A failure in the repair may result in a new problem or even result in a crash of the system. Therefore, it is determined at the end of the system repair whether there is abnormality in the repair.

For example, for such a case that a restoring strategy for the registry is to restore the registry with default values while the Trojan program or virus checks whether a registry entry is repaired at regular intervals and overwrites the registry entry once the registry entry is repaired, it is not reasonable to restore the registry with the default values directly because the registry may be overwritten after being repaired. In the case that certain entries, which were repaired by security software in the system, are overwritten, it is determined that the system repair is abnormal.

A strategy for the abnormality-determining module 506 to determine whether the repair for a system file is abnormal may include performing an abnormality monitoring for the repaired system file and the repaired registry. For example, the monitoring may include: submitting the system file on which the repair was performed and the system file used in the repair to a background server to confirm that the system file on which the repair was performed may bring in a system security issue and the system file used in the repair may not bring in the security issue. By performing the abnormality monitoring on the system file used in the repair, a re-infection of the repaired system file may be detected and the repair is determined as an abnormal repair, hence a repeat overwrite by the virus is avoided.

For the repair of the registry, if a strategy for repairing the registry is to restore the registry with default registry values, it may be checked whether the restored default registry values are overwritten by the virus; and in the case that certain entries repaired by the system security software are overwritten, it is determined that the repair is abnormal.

Moreover, if the strategy for repairing the registry is to modify the registry by user or by the system security software, the registry modified according to the modification strategy is compared to the modification for the registry made by the user or system security software before the system repair. Furthermore, an attribute of a file corresponding to the modified entry is checked and a security verification is performed. If there is no user setting value for the registry entry to be modified, the registry entry is modified to a default value and the repair is determined as normal. If there is a user setting value for the registry entry to be modified, the object directed by the user setting value is determined and the object is submitted to the background to detect whether there is a security risk. If there is the security risk, it is determined that the repair is abnormal; and if there is no security risk, it is determined that the repair is normal.

It should be noted that, for the repair strategy of the registry, the repaired registry entries are compared with the registry entries before the repair to determine whether there is a user-modified entry, the value of user-modified entry is searched and the security of the user-modified entry is checked, to determine whether the entry is set with the default value in accordance with the repair strategy or is modified to the user setting value before being modified by the virus. If no security risk will be brought by the user setting value while the registry entry is set as the default value according to the modification strategy, it is considered that the repair is abnormal; or if the user does not modify the entry but the registry entry is modified to a non-default value according to the strategy, it is also determined that the repair is abnormal.

In the case that it is determined that the system repair is abnormal or the user needs to restore the repaired system manually, it is necessary to restore the repaired system to avoid other system issues caused by the abnormal repair. The system file and the registry are each restored to the status before the system repair according to the status information of the system which is recorded before the system repair. A restoring approach is as follows.

For a system file, a status information table of the system file is searched; a type of the modification performed on the system file is determined based on MD5 information; then a corresponding important or unimportant file set is searched in the same way; finally, corresponding version information and verification information are found, and a corresponding system file is searched among backup files, with which the system file is restored.

As shown in Table 1, if it is determined that the system repair is abnormal, a change in MD517 is firstly determined; then a change in drive verification information MD547 is found out; finally, it is determined that the abnormality is caused by the change in MD54 as a result for repairing a system file: fastfat.sys; accordingly, this system file is restored.

For the registry, there are two ways for restoring: one way is to search an original setting of a modified registry entry according to recorded status information of the registry and restore the repaired setting to the original setting; the other way is to feedback the modification of the registry to the user to enable the user to designate an entry to be restored manually.

An approach for restoring the registry is similar to the approach for restoring the system file, and the approach includes: finding a corresponding registry entry of a corresponding type and restoring the registry entry into a recorded status until the restoring is finished.

In the embodiment, a security check is performed on a system file and a registry, whether a system needs to be repaired is determined based on a result of the security check and repair is performed on the system file and/or the registry if the system needs to be repaired. In addition, after the system is repaired, whether the system repair is abnormal is further detected, and if the system repair is abnormal, the system is recovered to a normal status according to status information of the system which is previously recorded; and a designated restore may be also performed manually. If the system repair is normal, it is determined that the system repair is completed. Therefore, possible abnormality in the system repair is avoided, risk in the system repair is reduced, security and accuracy of the system repair are improved, and the reliability of the repair is ensured.

Furthermore, the present disclosure further provides a computer readable storage medium, on which a program enabling a computer to run is stored, wherein, after being loaded into a storage of the computer, the program enables the computer to: perform a security check on a system file and a registry in a system, determine whether it is needed to repair the system file and/or the registry according to a preset rule for system repair in the case that a result of the security check indicates an abnormality, and repair the system file and/or the registry in the case that it is needed to repair the system file and/or the registry.

Although the foregoing embodiments are described by taking the Windows operating system as an example, to the disclosure is not limited to the Windows operating system. Other types of operating systems may also be repaired by using the above solutions of the present disclosure, such as a Mac system or a Linux system, and the principle of the repair will not be described herein.

Preferable embodiments of the present disclosure are illustrated above, and the scope of the disclosure is not limited thereto. Any equivalent structures or flow transformations made in light of the specification and drawings of the disclosure, or direct or indirect applications in other related technical fields fall in the scope of the disclosure.

1. A method for system repair, comprising:
performing a security check on a system file and a registry in a system;
determining whether it is needed to repair at least one of the system file and the registry according to a preset rule for the system repair, in the case that a result of the security check indicates an abnormality; and
repairing the at least one of the system file and the registry when it is determined that it is needed to repair the at least one of the system file and the registry.

2. The method according to claim 1, wherein:
after the step of determining whether it is needed to repair the at least one of the system file and the registry, the method further comprises recording status information of the system; and
after the step of repairing the at least one of the system file and the registry, the method further comprises restoring the system according to the recorded status information of the system.

3. The method according to claim 2, wherein before the step of restoring the system, the method further comprises:
determining whether the system repair is abnormal; and
restoring the system in the case that the system repair is abnormal.

4. The method according to claim 1, wherein the step of performing the security check on the system file and the registry in the system comprises:
checking whether a current system file matches with the system, and determining that the current system file is abnormal in the case that the current system file does not match with the system; and
checking whether there is a maliciously modified entry in current information of the registry, and determining that the registry is abnormal in the case that there is the maliciously modified entry.

5. The method according to claim 4, wherein the step of determining whether the system file needs to be repaired according to the result of the security check and the preset rule for the system repair comprises:
in the case that the system file is abnormal, determining whether the system file is important; determining that the system file needs to be repaired in the case that the system file is important, and determining that the system file does not need to be repaired in the case that the system file is not important.

6. The method according to claim 4, wherein the step of determining whether the registry needs to be repaired according to the result of the security check and the preset rule for the system repair comprises:
comparing the current information of the registry with default settings of corresponding entries in the registry in the case that the current information of the registry is abnormal; and
determining that the registry needs to be repaired in the case that there is a maliciously-modified important registry entry among the corresponding entries in the registry or in the case that there is a startup entry among the corresponding entries that points to a dangerous file, and determining that the registry does not need to be repaired in the case that there is no maliciously-modified important registry entry among the corresponding entries in the registry and there is no startup entry among the corresponding entries that points to a dangerous file.

7. The method according to claim 2, wherein the step of recording the status information of the system comprises:
recording status information of the system file and status information of the registry, and
at least one of compressing, encrypting and backing up the status information.

8. A device for system repair, comprising:
a security-checking module, configured to perform a security check on a system file and a registry in a system;
a repair-determining module, configured to determine whether it is needed to repair at least one of the system file and the registry according to a preset rule for the system repair, in the case that a result of the security check indicates an abnormality; and
a repair module, configured to repair the at least one of the system file and the registry in the case that the repair-determining module determines that it is needed to repair the at least one of the system file and the registry.

9. The device according to claim 8, further comprising:
a status-recording module, configured to record status information of the system; and
a restoration module, configured to restore the system according to the status information of the system recorded by the status-recording module.

10. The device according to claim 8, further comprising:
an abnormality-determining module, configured to determine whether the system repair is abnormal;
wherein the restoration module is configured to restore the system in the case that the system repair is abnormal.

11. The device according to claim 8, wherein the security-checking module is further configured to: check whether a current system file matches with the system and determine that the current system file is abnormal in the case that the current system file does not match with the system; and check whether there is a maliciously modified entry in current information of the registry and determine that the registry is abnormal in the case that there is the maliciously modified entry.

12. The device according to claim 8, wherein:
the repair-determining module is further configured to determine whether the system file is important in the case that the system file is abnormal, determine that the system file needs to be repaired in the case that the system file is important and determine that the system file does not need to be repaired in the case that the system file is not important; and
the repair-determining module is further configured to compare the current information of the registry with default settings of corresponding entries in the registry in the case that the current information of the registry is abnormal, determine that the registry needs to be modified in the case that there is a maliciously-modified important registry entry among the corresponding entries in the registry or in the case that there is a startup entry among the corresponding entries that points to a dangerous file, and determine that the registry does not need to be modified in the case that there is no maliciously-modified important registry entry among the corresponding entries in the registry and there is no startup entry among the corresponding entries that points to a dangerous file.

13. The device according to claim 9, wherein the status-recording module is further configured to record status information of the system file and status information of the registry respectively and to at least one of compress, encrypt and back up the status information.

14. A computer readable storage medium on which a program enabling a computer to run is stored, wherein, after being loaded into a storage of the computer, the program enables the computer to: perform a security check on a system file and a registry in a system, determine whether it is needed to repair at least one of the system file and the registry according to a preset rule for system repair in the case that a result of the security check indicates an abnormality, and repair the at least one of the system file and the registry in the case that it is needed to repair the at least one of the system file and the registry.
